(19) United States
(12) Patent Application Publication
(10) Pub. No.: US 2024/0363132 A1
(43) Pub. Date: Oct. 31, 2024

(54) HIGH-PERFORMANCE SMALL-FOOTPRINT AI-BASED NOISE SUPPRESSION MODEL

(71) Applicant: SKYWORKS SOLUTIONS, INC., Irvine, CA (US)

(72) Inventors: Meysam ASGARI, Lake Oswego, OR (US); Merlin Phillip CARSON, Portland, OR (US)

(21) Appl. No.: 18/643,539

(22) Filed: Apr. 23, 2024

Related U.S. Application Data
(60) Provisional application No. 63/461,665, filed on Apr. 25, 2023.

(51) Int. Cl. G10L 21/0232; G10L 15/06; G10L 25/30

(52) U.S. Cl. CPC G10L 21/0232; G10L 15/063; G10L 25/30

(57) ABSTRACT

In some embodiments, a system can be configured to receive audio data including a known noisy acoustic signal, the known noisy acoustic signal including a known clean acoustic signal and at least one known additive noise. The system may transform the audio data into frequency-domain data. The system may train a convolutional neural network based on the frequency-domain data and at least one of the known clean acoustic signal or the known additive noise, wherein the convolutional neural network is configured to: output a frequency multiplicative mask to be applied to the frequency-domain data to estimate the known clean acoustic signal, and include an encoder configured to upsample the frequency-domain data into a feature space.

### CROSS-REFERENCE TO RELATED APPLICATIONS

This application claims priority to U.S. Prov. App. No. 63/461,665 filed Apr. 25, 2023, and entitled “HIGH-PERFORMANCE SMALL-FOOTPRINT AI-BASED NOISE SUPPRESSION MODEL,” which is expressly incorporated by reference herein in its entirety for all purposes.

### BACKGROUND

### Field

Electronic speech signals can be disrupted due to environmental, measurement, or transmission noise. This can reduce perceptual quality and intelligibility, which results in poor communication experiences.

### Description of the Related Art

Speech enhancement is one of the cornerstones of building robust automatic speech recognition (ASR) and communication systems. The objective of speech enhancement is improvement in intelligibility and/or overall perceptual quality of degraded speech signal using audio signal processing techniques. For example, speech enhancement techniques are used to reduce noise in speech degraded by noise and used for many applications such as mobile phones, voice over IP (VOIP), teleconferencing systems, speech recognition, hearing aids, and wearable audio devices.

Modern speech enhancement systems and techniques are often built using data-driven approaches based on large scale deep neural networks. Speech enhancement techniques using deep neural networks have seen limited use due to their model size and heavy computational requirements. For instance, deep neural network-based speech enhancement methods are too cumbersome for use in wearable device applications as such solutions have been too heavy (e.g., having too many parameters to implement) and too slow in latency.

### SUMMARY

According to a number of implementations, the techniques described in the present disclosure relates to a computer-implemented method including: receiving audio data including a known noisy acoustic signal, the known noisy acoustic signal including a known clean acoustic signal and at least one known additive noise; transforming the audio data into frequency-domain data; and training a convolutional neural network based on the frequency-domain data and at least one of the known clean acoustic signal or the known additive noise, wherein the convolutional neural network is configured to: output a frequency multiplicative mask to be applied to the frequency-domain data to estimate the known clean acoustic signal, and include an encoder configured to upsample the frequency-domain data into a feature space.

In some aspects, the techniques described herein relate to a computer-implemented method further including multiplying the frequency multiplicative mask to the frequency-domain data to estimate the known clean acoustic signal.

In some aspects, the techniques described herein relate to a computer-implemented method wherein spatial dimensions specified by width and height of the frequency-domain data remain the same before and after a performance of at least one 2-dimensional convolutional layer of the encoder.

In some aspects, the techniques described herein relate to a computer-implemented method wherein the convolutional neural network includes a decoder configured to downsample the feature space into the frequency multiplicative mask.

In some aspects, the techniques described herein relate to a computer-implemented method wherein spatial dimensions specified by width and height of the frequency-domain data remain the same before and after a performance of at least one 2-dimensional convolutional layer of the decoder.

In some aspects, the techniques described herein relate to a computer-implemented method further including constructing the convolutional neural network, including a plurality of neurons arranged in a plurality of layers including encoding layers and decoding layers wherein the encoding layers and decoding layers include 2-dimensional convolutional layers.

In some aspects, the techniques described herein relate to a computer-implemented method wherein each of the encoding layers and the decoding layers includes a 2-dimensional convolution followed by a batch normalization followed by a rectified linear unit activation.

In some aspects, the techniques described herein relate to a computer-implemented method wherein a first layer of the plurality of layers is configured to encode frequencies in the frequency-domain data into a higher-dimension feature space in comparison with an original dimension of the frequency-domain data, and a second layer of the plurality of layers is configured to decode feature space to lower-dimension in comparison with the higher-dimension feature space.

In some aspects, the techniques described herein relate to a computer-implemented method further including providing the trained convolutional neural network to a wearable or portable audio device wherein the audio device is capable of: receiving real-time audio data, transforming the real-time audio data into real-time frequency-domain data, outputting a real-time frequency multiplicative mask using the trained convolutional neural network and the real-time audio data, and applying the real-time frequency multiplicative mask to the real-time frequency-domain data.

In some aspects, the techniques described herein relate to a computer-implemented method wherein the frequency multiplicative mask is a phase-aware complex ratio mask.

In some aspects, the techniques described herein relate to a computer-implemented method wherein the known noisy acoustic signal is a known noisy speech signal and the known clean acoustic signal is a known clean speech signal.

In some aspects, the techniques described herein relate to a system including: a combination of a high fidelity digital signal processor (HiFi DSP) paired with a neural processing unit (NPU) for real-time audio processing; and one or more processors configured to execute instructions on the combination to perform a method including: transforming input audio data into frequency-domain data; perform inference with a trained convolutional neural network, executed on the combination of the HiFi DSP paired with the NPU, to output a frequency multiplicative mask, the convolutional neural network including an encoding layer configured to upsample the frequency-domain data into a feature space; applying the frequency multiplicative mask to the frequency-domain data; and estimating a noise suppressed version of the input audio data.

In some aspects, the techniques described herein relate to a system wherein the convolutional neural network includes a decoding layer configured to downsample the feature space into the frequency multiplicative mask.

In some aspects, the techniques described herein relate to a system wherein the encoding layer and the decoding layer include 2-dimensional convolutional layers.

In some aspects, the techniques described herein relate to a system wherein the decoding layer is configured to increase a number of channels.

In some aspects, the techniques described herein relate to a system wherein the HiFi DSP is of Tensilica® HiFi DSP family.

In some aspects, the techniques described herein relate to a system wherein the HiFi DSP is HiFi 5 DSP of Tensilica® HiFi DSP family.

In some aspects, the techniques described herein relate to a system wherein the NPU is of Tensilica® neural network engine (NNE) family.

In some aspects, the techniques described herein relate to a system wherein the NPU is NNE 110 of Tensilica® NNE family.

In some aspects, the techniques described herein relate to a computer-readable storage device storing instructions that, when executed by one or more processors, cause the one or more processors to perform a method including: receiving audio data including a known noisy acoustic signal, the known noisy acoustic signal including a known clean acoustic signal and at least one known additive noise; transforming the audio data into frequency-domain data; and training a convolutional neural network based on the frequency-domain data and at least one of the known clean acoustic signal or the known additive noise, wherein the convolutional neural network: output a frequency multiplicative mask to be applied to the frequency-domain data to estimate the known clean acoustic signal, and includes an encoder configured to upsample the frequency-domain data into a feature space.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

Various embodiments are depicted in the accompanying drawings for illustrative purposes and should in no way be interpreted as limiting the scope of the inventions. In addition, various features of different disclosed embodiments can be combined to form additional embodiments, which are part of this disclosure. Throughout the drawings, reference numbers may be reused to indicate correspondence between reference elements.

FIG. 1 depicts a system that includes a wearable audio device in communication with a host device, where the wearable audio device includes an audio amplifier circuit.

FIG. 2 shows that the wearable audio device of FIG. 1 can be implemented as a device configured to be worn at least partially in an ear canal of a user.

FIG. 3 shows that the wearable audio device of FIG. 1 can be implemented as part of a headphone configured to be worn on the head of a user, such that the audio device is positioned on or over a corresponding ear of the user.

FIG. 4 shows that in some embodiments, the audio amplifier circuit of FIG. 1 can include a number of functional blocks.

FIGS. 4A-4B illustrate end-to-end models based on deep neural networks for speech enhancement, according to embodiments of the present disclosure.

FIGS. 5A-5B illustrate example ultra-small noise suppression model architectures, according to embodiments of the present disclosure.

FIG. 6 illustrates an example detailed model of the ultra-small noise suppression model architecture, according to embodiments of the present disclosure.

FIG. 7 illustrates a speech enhancement framework, according to embodiments of the present disclosure.

FIG. 8 is a flowchart illustrating a method for improved real-time audio processing, according to embodiments of the present disclosure.

### DETAILED DESCRIPTION OF SOME EMBODIMENTS

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein. The headings provided herein, if any, are for convenience only and do not necessarily affect the scope or meaning of the claimed invention.

The present disclosure provides systems, devices, and methods for suppressing noise from noisy signals. The noisy signals can be speech signals, including monaural speech signals or binaural speech signals, where improving naturalness and intelligibility during communication are of importance. Gaming, lifestyle, wireless audio, enterprise communication, automotive command recognition, touchless interfaces, and the like are but few applications that could benefit from speech noise suppression.

Despite its wide applicability, providing effective speech noise suppression has been challenging due to speech signals involving many factors such as contained message, surrounding environment, speaker state, cross-talk, neighboring speakers, simultaneous speech, or the like while requiring high accuracy and intelligibility for the cleaned output signal.

Developments in artificial intelligence (AI) algorithms (e.g., deep neural networks) started matching or outperforming digital signal processing (DSP) algorithms. However, speech enhancement techniques using deep neural networks have seen limited use due to their model size and heavy computational requirements. For instance, deep neural network-based speech enhancement methods were too cumbersome for use in wearable device applications as such solutions have been too heavy (e.g., having too many parameters to implement) and too slow in latency.

The present disclosure contemplates an improved speech noise suppression model to address the challenges in providing effective speech noise suppression having a small enough resource (e.g., computational and memory) footprint to be implemented on a wearable device (e.g., portable device). Additionally, the present disclosure contemplates a specific hardware combination that can run the model in real-time (e.g., having a real-time-factor below the real-time threshold of 1).

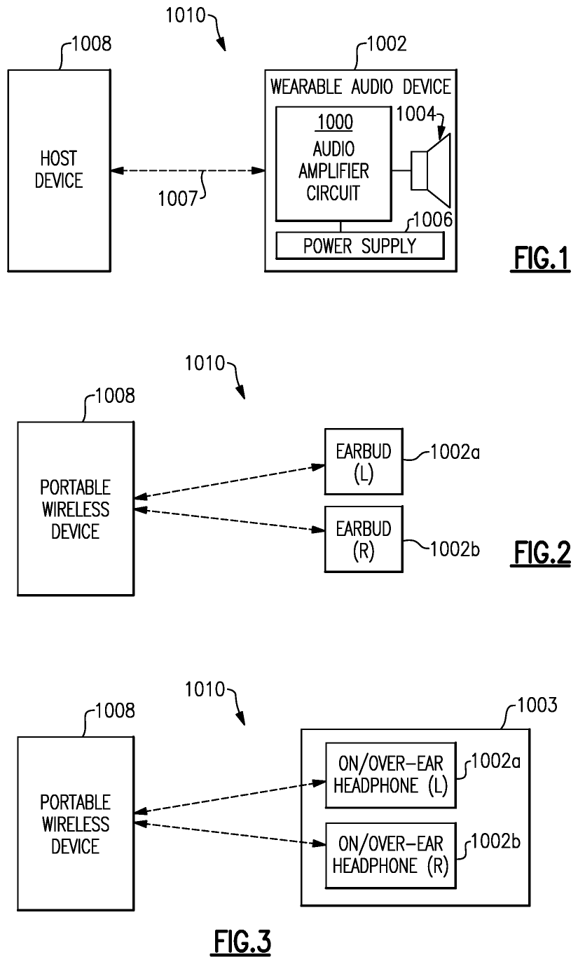

FIG. 1 depicts a system 1010 that includes a wearable audio device 1002 in communication with a host device 1008. Various embodiments of the present disclosure may be implemented at the wearable audio device 1002 or the host device 1008. A wearable audio device can be worn by a user to allow the user to enjoy listening of an audio content stream being played by a mobile device. Such an audio content stream may be provided from the mobile device to the wearable audio device through, for example, a short-range wireless link. Once received by the wearable audio device, the audio content stream can be processed by one or more circuits to generate an output that drives a speaker to generate sound waves representative of the audio content stream.

Such communication, depicted as 1007 in FIG. 1, can be supported by, for example, a wireless link such as a short-range wireless link in accordance with a common industry standard, a standard specific for the system 1010, or some combination thereof. In some embodiments, the wireless link 1007 includes digital format of information being transferred from one device to the other (e.g., from the host device 1008 to the wearable audio device 1002).

In FIG. 1, the wearable device 1002 is shown to include an audio amplifier circuit 1000 that provides an electrical audio signal to a speaker 1004 based on a digital signal received from the host device 1008. Such an electrical audio signal can drive the speaker 1004 and generate sound representative of a content provided in the digital signal, for a user wearing the wearable device 1002.

In FIG. 1, the wearable device 1002 is a wireless device; and thus typically includes its own power supply 1006 including a battery. Such a power supply can be configured to provide electrical power for the audio device 1002, including power for operation of the audio amplifier circuit 1000. It is noted that since many wearable audio devices have small sizes for user-convenience, such small sizes places constraints on power capacity provided by batteries within the wearable audio devices.

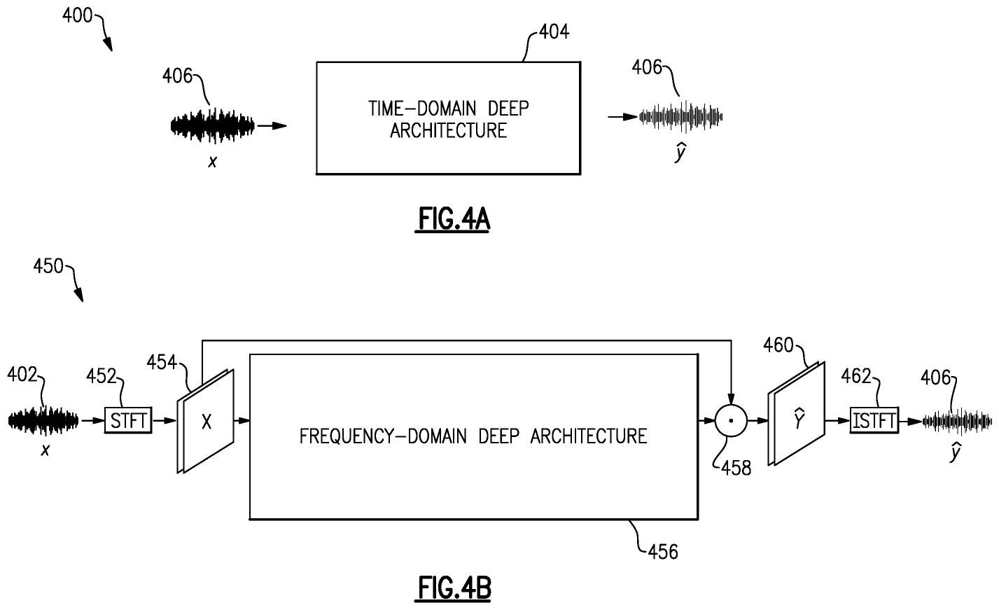

In some embodiments, the host device 1008 can be a portable wireless device such as, for example, a smartphone, a tablet, an audio player, etc. It will be understood that such a portable wireless device may or may not include phone functionality such as cellular functionality. In such an example context of a portable wireless device being a host device, FIGS. 2 and 3 show more specific examples of wearable audio devices 1002 of FIG. 1.

For example, FIG. 2 shows that the wearable audio device 1002 of FIG. 1 can be implemented as a device (1002a or 1002b) configured to be worn at least partially in an ear canal of a user. Such a device, commonly referred to as an earbud, is typically desirable for the user due to compact size and light weight.

In the example of FIG. 2, a pair of earbuds (1002a and 1002b) can be provided—one for each of the two ears of the user—and each earbud can include its own components (e.g., audio amplifier circuit, speaker and power supply) described above in reference to FIG. 1. In some embodiments, such a pair of earbuds can be operated to provide, for example, stereo functionality for left (L) and right (R) ears.

In another example, FIG. 3 shows that the wearable audio device 1002 of FIG. 1 can be implemented as part of a headphone 1003 configured to be worn on the head of a user, such that the audio device (1002a or 1002b) is positioned on or over a corresponding ear of the user. Such a headphone is typically desirable for the user due to audio performance.

In the example of FIG. 3, a pair of audio devices (1002a and 1002b) can be provided—one for each of the two ears of the user. In some embodiments, each audio device (1002a or 1002b) can include its own components (e.g., audio amplifier circuit, speaker and power supply) described above in reference to FIG. 1. In some embodiments, one audio device (1002a or 1002b) can include an audio amplifier circuit that provides outputs for the speakers of both audio devices. In some embodiments, the pair of audio devices 1002a, 1002b of the headphone 1003 can be operated to provide, for example, stereo functionality for left (L) and right (R) ears.

In audio applications, wearable or otherwise, additive background noise contaminating the target speech negatively impacts the quality of speech communication and results in reduced intelligibility and perceptual quality. It may also degrade the performance of automatic speech recognition (ASR) systems.

Traditionally, speech enhancement methods aimed at suppressing the noise component from the contaminated speech using conventional signal processing algorithms such as Wiener filtering. However, their performances are very sensitive to the characteristics of the background noise and greatly decrease in low signal-to-noise (SNR) conditions with non-stationary noises. Further, noise suppression algorithms for speech signals using classical signal processing techniques (e.g., wiener filter-based algorithms) provide limited capabilities regarding removing continuous, stationary disruptions in a signal. These types of algorithms typically do not readily differentiate between speech and non-speech and does not model noise that has high variance in either frequency or duration.

Today, various noise suppression methods based on deep neural networks (DNNs) show some promise in overcoming the challenges of the conventional signal processing algorithms. For example, recent trends in Artificial Intelligence (AI) have shown that deep neural networks (DNNs) are capable of distinguishing between speech and non-speech, empowering algorithms to remove highly time or frequency varying non-speech sounds with almost no perceptible latency and making them capable of performing state-of-the-art noise suppression. The proposed networks of the present disclosure can learn a complex non-linear function to recover target speech from noisy speech.

FIGS. 4A-4B illustrate end-to-end models 400, 450 based on deep neural networks for speech enhancement, according to embodiments of the present disclosure. Both models 400, 450 may receive an input acoustic signal (e.g., input audio waveform) containing additive noise component, process the input acoustic signal to filter the noise component, and provide an output acoustic signal (e.g., output audio waveform) free of noise or with suppressed noise component. In some instances, the input acoustic signal may be a noisy speech 402 and the output acoustic signal may be a target speech (e.g., clean speech or estimated speech) 406. In some instances, the noisy speech 402 can be processed by, depending on characteristics of the noisy speech 402 and its context, a single-channel speech enhancement algorithm or a multi-channel speech enhancement algorithm to provide the target speech 406.

The DNN-based noise suppression methods can be broadly categorized into (i) time-domain methods, (ii) frequency-domain methods, and (iii) time-frequency domain (hybrid) methods. FIG. 4A illustrates a time-domain end-to-end model 400 and FIG. 4B illustrates a frequency-domain end-to-end model 450. Both models 400, 450 can be trained in a supervised fashion with real or synthesized noisy speech 402 as the input and clean speech (e.g., target speech or estimated speech) 406 as an output of the network.

The time-domain end-to-end model 400 can map the noisy speech 402 to the clean speech 406 through a time-domain deep architecture 404. During training, various parameters in a time-domain deep architecture 404 can be tuned, such as by adjusting various weights and biases. The trained time-domain deep architecture 404 can function as a “filter” in a sense that the time-domain deep architecture 404, when properly trained and implemented, can remove the additive noise from the noisy speech 402 and provide the clean speech 406.

Similarly, the frequency-domain end-to-end model 450 can map the noisy speech 402 to the clean speech 406 through a frequency-domain deep architecture 456. Instead of directly mapping the noisy speech 402 to the clean speech 406 as illustrated in the time-domain end-to-end model 400, the frequency-domain methods can extract input spectral features 454 from the noisy speech 402 and provide the input spectral features 454 to the frequency-domain deep architecture 456. The input spectral features 454 may be extracted using various types of Fourier transform 452 (e.g., short-time Fourier transform (STFT), discrete-time Fourier transform (DFT), fast Fourier transform (FFT), or the like) that transforms time-domain signals into frequency-domain signals. In some instances, the input spectral features 454 can be associated with a set of frequency bins. For example, when the noisy speech 402 sample rate is 100 Hz and FFT size is 100, then there will be 100 points between [0 100) Hz that divides the entire 100 Hz range into 100 intervals (e.g., 0-1 Hz, 1-2 Hz, . . . , 99-100 Hz). Each such small interval can be a frequency bin.

During training, various parameters in the frequency-domain deep architecture 456 can be tuned, such as by adjusting various weights and biases to determine a frequency multiplicative mask that can be applied to the input spectral features 454 to remove the additive noise. For example, the frequency-domain end-to-end model 450 illustrates an operation (e.g., multiplication) 458 that takes in as inputs the input spectral features 454 and the frequency multiplicative mask determined through the training process. In some instances, the frequency multiplicative mask can be a phase-sensitive mask. For example, the frequency multiplicative mask can be a complex ratio mask that contains the real and imaginary parts of the complex spectrum. That is, the frequency-domain deep architecture 456 may include complex-valued weights and complex-valued neural networks.

The output spectral features 460 that results from the operation 458 can include input spectral features 454 that have attenuated the noise power across the frequency bins. The output spectral features 460 can further go through an inverse Fourier transform 462 to ultimately provide the clean speech 406.

Generally, the time-domain end-to-end model 450 that directly (e.g., without time-frequency domain transform) estimate clean speech waveforms through end-to-end training can suffer from challenges arising from modeling long sequences as the long sequences often require very deep architecture with many layers. Such deep convolutional layers can involve too many parameters. More particularly, when designing models for real-time speech enhancement in a mobile or wearable device, it may be impractical to apply too many layers or non-causal structures.

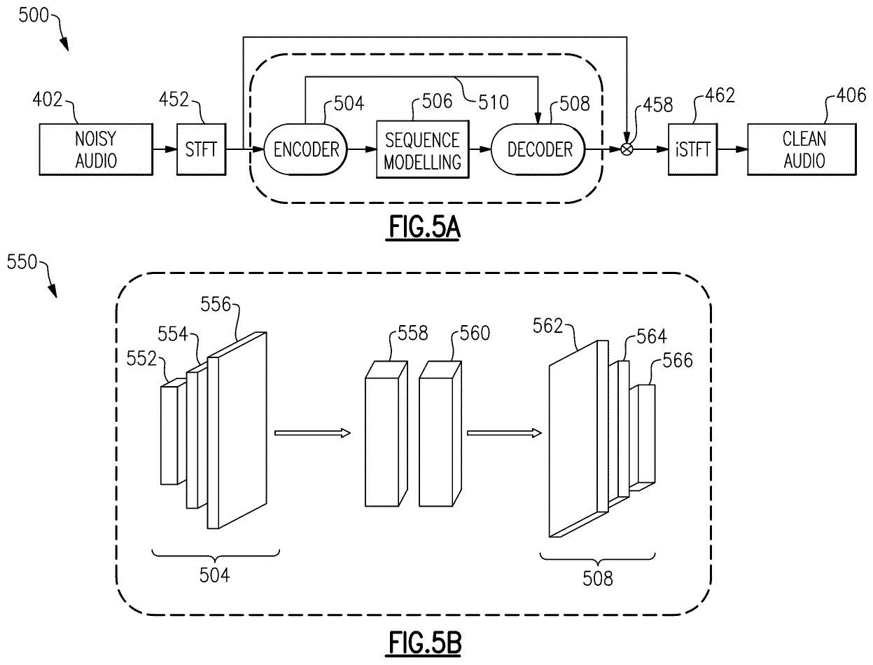

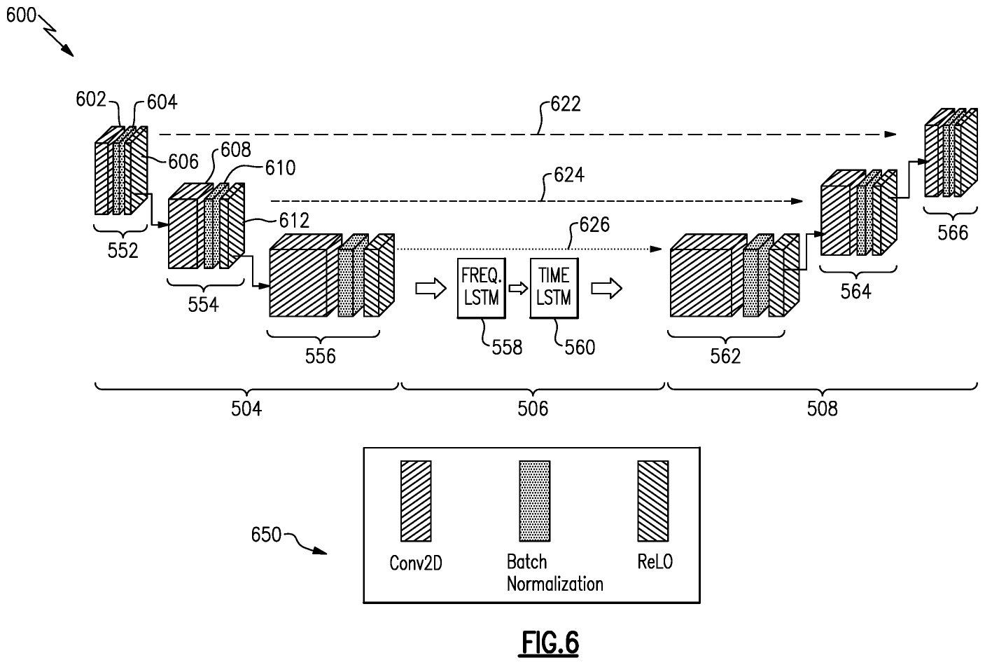

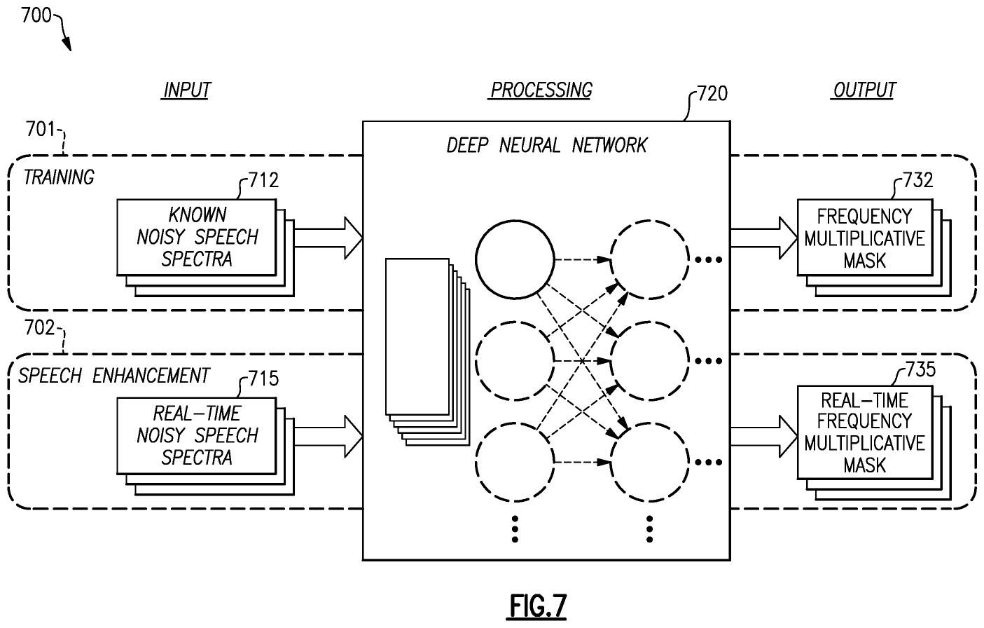

In some instances, the time-frequency (T-F) domain methods (not shown) can combine some aspects of time-domain methods and frequency-domain methods to provide an improved noise cancelling capability with reduced parameter count. T-F domain methods can, similar to the frequency-domain methods, extract spectral features of a frame of acoustic signal using the transform 452. It was described that the frequency-domain method 450 can train a deep neural architecture 456 with the extracted spectral features 454, or local features, of each frame. In addition to the local spectral features, the T-F method can additionally model variations of the spectrum over time between consecutive frames. For example, the T-F method may take advantage of temporal information in the acoustic signal using one or more long-short term memory (LSTM) layers. A new end-to-end model for speech enhancement that provides sufficient noise filtering capability with fewer parameters will be described in greater detail with respect to FIGS. 5A-5B.

FIG. 5A illustrates an ultra-small noise suppression model architecture 500, according to embodiments of the present disclosure. The model architecture can build on the frequency-domain end-to-end model 450 of FIG. 4B. Specifically, the ultra-small noise suppression model architecture 500 can include (i) an encoder block 504, (ii) a sequence modelling block 506, and (iii) a decoder block 508. The model architecture 500 can include a neural network, including a plurality of neurons, the plurality of neurons arranged in a plurality of layers, including at least one hidden layer, and being connected by a plurality of connections. In some implementations, the model architecture may construct the neural network as a convolutional neural network.

FIG. 5B illustrates an example deep architecture 550 of the ultra-small noise suppression model architecture 500 in greater detail, according to embodiments of the present disclosure. As the example deep architecture 550 illustrates, the ultra-small noise suppression model architecture 500 can differ from traditional deep learning architectures with dimensionality changes at the encoder 504 and the decoder 508.

The deep architecture 550 can include any number of 2-D convolutional (Conv2D) layers in the encoder block 504 that map frequencies into a higher-dimension feature space (as opposed U-net architecture encoders that map to lower-dimension feature space) and any number of Conv2D layers in the decoder block 508 that map from the higher-dimension feature space to lower-dimension frequency masks (as opposed to U-net architecture decoders that map to higher-dimension segmentation map). The frequency masks can be complex masks that are phase-aware. While the example deep architecture 550 shows three Conv2D layers 552, 554, 556 for the encoder block 504 and three Conv2D layers 562, 564, 566 for the decoder block 508, it will be understood that there could be fewer or more layers. In some embodiments, the decoder block 508 may consist of only Conv2D layers without any 2-D convolutional transpose (Conv2DTranspose) layers.

The increase in dimensionality at the encoder block 504 can be, in some aspects, similar to architecture and operation of an overcomplete autoencoder. An overcomplete autoencoder is an autoencoder architecture where the dimensionality of the latent space is larger than the dimensionality of the input data. In other words, the number of neurons in the hidden layer is greater than the number of neurons in the input layer or the number of neurons in the output layer. In comparison with a typical autoencoder, an overcomplete autoencoder increases the dimensionality of the latent space, thereby allowing the autoencoder to learn a more expressive representation of the input data.

Like the encoders of overcomplete autoencoders, the encoder block 504 can map frequencies into a higher-dimensional feature space (e.g., increase dimensionality of its latent space). In some embodiments, each following Conv2D layer of the encoder block 504 increases dimensionality, number of channels, and/or number of feature maps by progressively including more filters. The Conv2D layers of the encoder block 504 can extract local patterns from noisy speech spectrogram and increase the feature resolution. In some embodiments, real and imaginary parts of complex spectrogram of the noisy speech 402 can be sent to the encoder block 504 as two streams. Additionally, in some embodiments, the encoder block 504 can provide skip connections 510 between one or more Conv2D layers of the encoder block 504 and one or more Conv2D layers of the decoder block 508 to pass some detailed information of the noisy speech spectrogram.

The sequence modeling block 506 can model long-term dependencies to leverage contextual information in time and frequency. Here, some additional layers and operations can be provided to further configure the deep architecture 550. For example, one or more LSTM layers (e.g., a frequency LSTM layer 558 and/or a time LSTM layer 560) as shown, normalization layers, or computational functions (e.g., rectified linear unit (ReLU) activation function, SoftMax function, etc.) can be added to better capture variations of the extracted and convoluted spectrum over time between consecutive frames. Specifically, the frequency LSTM layer 558 can extract frequency information and the time LSTM layer 560 can extract temporal information. Accordingly, the LSTM layers can leverage contextual information in both feature and time. In some embodiments, as shown, the time LSTM layer 560 can follow the frequency LSTM layer 558. In some other embodiments, the frequency LSTM layer 558 can follow the time LSTM layer 560.

The decoder block 508 can map from a higher-dimension feature space to a lower-dimension frequency mask (e.g., decreased dimensionality). In some embodiments, each following Conv2D layer of the decoder block 508 can decrease dimensionality, number of channels, and/or number of feature maps by progressively including fewer filters. In some embodiments, the decoder block 508 can use Conv2D layers to return high-resolution features to the original size, thereby forming a symmetric structure with the encoder block 504. In some implementations, the outputs from the decoder block 508 can include real and imaginary parts of complex spectrogram as two streams. As described, the deep architecture 550 can include one or more skip connections between the encoder block 504 and the decoder block 508.

FIG. 6 illustrates an example detailed model 600 of the ultra-small noise suppression model architecture 500, according to embodiments of the present disclosure. The detailed model 600 can be the entire or be a portion of the deep architecture 550 of FIG. 5B.

The detailed model 600 can include multiple layers (e.g., Conv2D layers) where the number of layers represents depth of a neural network. In the example detailed model 600, the depth is three with the encoder block 604 including three layers 552, 554, 556 that correspond to three layers 562, 564, 566 of the decoder block 508, but greater or lesser depth in the detailed model 600 is possible. Each encoder layer 552, 554, 556 and its corresponding decoder layer 562, 564, 566 may be connected by a skip connection 622, 624, 626, as shown.

Referring to an operation legend 650, it is seen that each layer of the detailed model 600 may comprise a Conv2D layer, followed by batch normalization, followed by a ReLU function. For example, a first encoding layer 552 includes a first Conv2D layer, followed by a first batch normalization, followed by a first ReLU function. As another example, a second encoding layer 554 includes a second Conv2D layer 608, followed by a second batch normalization 610, followed by a second ReLU function 612. As shown, other layers, including decoding layers 562, 564, 566 can similarly include a Conv2D layer, batch normalization, and ReLU function.

As described in relation to the deep architecture 550 of FIG. 5B, the detailed model 600 can take an approach based in part on the overcomplete autoencoder family of architectures. Unlike other U-Net architectures that initially downsample frequency bins through the encoder block 504 then upsample via the decoder block 508, in the overcomplete autoencoder-based this approach, frequency bins can undergo initial upsampling via the encoder block 504 and then downsampling via the decoder block 508.

In the detailed model 600, the upsampling at the encoder block 504 and downsampling at the decoder block 508 can involve, respectively, increasing or decreasing dimensionality, number of channels, and/or number of feature maps while maintaining the same or substantially the same width and height (e.g., 2-D spatial dimensions of input data) between layers. For example, the encoding and decoding layers 552, 554, 556, 562, 564, 566 show the same or substantially the same width and height. However, each of the layers show increasing or decreasing number of channels for their Conv2D layer in comparison to neighboring Conv2D layer. In some embodiments, only the number of channels may change while the width and height remain the same.

### Training and Implementation

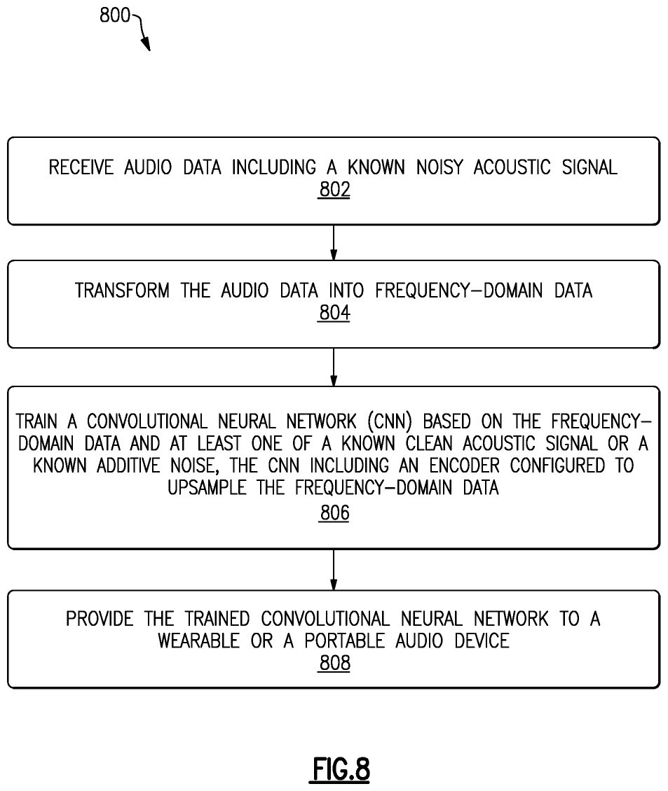

FIG. 7 illustrates a speech enhancement framework 700, according to embodiments of the present disclosure. The speech enhancement framework 700 may be embodied in certain control circuitry, including one or more processors, data storage devices, connectivity features, substrates, passive and/or active hardware circuit devices, chips/dies, and/or the like. Specifically, the speech enhancement framework can be small enough in computation and memory footprint that the framework 700 can be implemented in or for a wearable, portable, or other embedded audio devices. For example, the framework 700 may be embodied in the wearable audio device 1002 or the host device 1008 shown in FIGS. 1-3 and described above. The framework 700 may employ machine learning functionality to predict a frequency multiplicative mask that can attenuate noise power from a noisy acoustic signal to provide clean acoustic signal.

The framework 700 may be configured to operate on certain acoustic-type data structures, such as speech data with additive noise, which may be an original sound waveform or synthetic sound waveform constructed. Such input data may be transformed using a Fourier transform and associated with frequency bins. The transformed input data can be operated on in some manner by certain deep neural network 720 associated with a processing portion of the framework 700. The framework 700 can involve a training process 701 and a speech enhancement process 702.

With respect to the training process 701, the deep neural network 720 may be trained according to known noisy speech spectra 712 and frequency multiplicative mask 732 corresponding to the respective known noisy speech spectra 712 as input/output pairs. The frequency multiplicative mask 732 may be a complex mask, an ideal ratio mask, or the like. The known noisy speech spectra 712 is known in the sense that known clean speech signal (or known additive noise) associated with the known noisy speech spectra 712 is known such that training can compare the clean speech signal and output signals resulting from application of the frequency multiplicative mask 732 to the known noisy speech spectra 712. During training, which may be supervised training, the deep neural network 720 can tune one or more parameters (e.g., weights, biases, etc.) to correlate the input/output pairs.

Referring back to FIG. 4B, while not shown in the framework 700, the known noisy speech spectra 712 can be spectral features of the noisy speech 402 that has been transformed. That is, the known noisy speech spectra 712 can correspond to the input spectra features 454 generated from Fourier-transforming the noisy speech 402. Like the operation 458, the frequency multiplicative mask 732 can be multiplied to the known noisy speech spectra 712 to provide output spectral features 460 that corresponds to a Fourier-transform of the clean speech 406 in FIG. 4B. During training, such output spectral features 460 can be compared to known clean speech spectra associated with the known noisy speech spectra 712 to tune the deep neural network 720.

The network 720 may include a plurality of neurons (e.g., layers of neurons, as shown in FIG. 7) corresponding to the parameters. The network 720 may include any number of convolutional layers, wherein more layers may provide for identification of higher-level features. The network 720 may further include one or more pooling layers, which may be configured to reduce the spatial size of convolved features, which may be useful for extracting invariant features. Once the parameters are sufficiently tuned to provide a frequency multiplicative mask 732 that satisfactorily suppresses noise component from the noisy speech 701, the parameters can be set. That is, the frequency multiplicative mask 732 can be set.

With respect to the speech enhancement process 702, the trained version of the deep neural network 720 having the set parameters can be implemented in a system or a device, such as the system 1010, wireless device 1008, or audio device 1002. When implemented, the trained version of the network 720 can receive a real-time noisy speech spectra 715 and provide a real-time frequency multiplicative mask 735 using the trained version. The real-time frequency multiplicative mask 735 can be applied (e.g., multiplied as illustrated with the operation 458 of FIG. 5A) to the real-time noisy speech spectra 715 to generate a noise-suppressed spectra of a clean speech signal.

### Hardware Combination

DNNs can be large computational graphs that learn arbitrary functions using a datacentric approach, optimizing parameters by determining an error between experimental outputs and their desired values by way of an objective function. For complex applications, DNNs can have a large number of parameters and mathematical operations, which may require a significant amount of memory and computational power, making them intractable for use in real-time systems on embedded platforms, such as a wearable or portable audio device.

Modern digital signal processors (DSP) such as a HiFi DSP (e.g., a high fidelity DSP of the Tensilica® HiFi DSP family, including HiFi 5) paired with a neural processing unit (NPU) (e.g., a neural network engine (NNE) of the Tensilica® NNE family, such as the NNE110) are designed to make DNN based applications possible for embedded systems. These processors have been highly optimized to do fixed-point mathematical operations, capable of, for example, up to 128 multiply-and-accumulates (MACs) per clock-cycle. To utilize this efficiency, the 32-bit real-valued parameters of a DNN may be fully quantized to, for example, 8-bit integers (e.g., for quantization, training, and inference).

The model 500, 550, 600 presented herein is an improved DNN, which can be a lightweight, low-latency, noise suppression model that is designed to run efficiently using a combination of a HiFi DSP and an NNE embedded processor can efficiently run the noise suppression model disclosed herein (e.g., the ultra-small noise suppression model and architectures 500, 550, 600) to perform real-time speech enhancement. For example, the model may use neural network operations that have been optimized to run efficiently on a combination of the HiFi5 and the NNE110 NPU, or other similar one or more DSPs, NPUs, or NNEs. The model may utilize or be based on a U-Net style, or other appropriate, convolutional neural network (CNN) architectures and models that may have a recurrent component, a single-path, a dual-path, or a multi-path (e.g., a dual-path convolution recurrent network as part of its model.

As input (e.g., at the head), the network can encode real and imaginary features from an audio spectrum into a new, learned feature space. The multi-path (e.g., dual-path or the like) section of the network can analyze the features across all frequency bands and may model long-term sequences in the signal. The tail of the network can decode the modeled signal output from the recurrent section of the network, producing a complex frequency mask. The mask can be applied to the incoming signal, suppressing the non-speech components, and resulting in speech enhancement.

The model 500, 550, 600 may consist of thousands of parameters (e.g., 302 thousands of parameters), which may involve a substantially smaller (e.g., only 337.7 kB) memory to store. In some embodiments, the model 500, 550, 600 may involve approximately 2.4 million HiFi/NNE clock-cycles to produce a single 16 millisecond frame of audio. Provided a clock speed of 400 MHz, this can result in a real-time-factor (RTF) of 0.6, significantly below the threshold needed to run the model in real-time. Additionally, the smaller memory footprint may enable implementation of the model 500, 550, 600 within an embedded device including an audio device such as an earbud, ear-insert, a headset, or other portable audio devices

Subjective evaluation among expert listeners using Multiple Stimuli with Hidden Reference and Anchor (MUSHRA) designed for the ITU-R BS.1534-3 standard for assessment of intermediate quality level of audio systems shows that the model 500, 550, 600 can perform on-par with other commercially available, desktop based, DNN noise suppression algorithms that require significantly more computing resources. Quantization of the trained model, evaluated at a signal-to-noise ratio (SNR) of 5 dB, showed an objective performance decrease of 0.5%, according to the Perceptual Evaluation of Speech Quality (PESQ) algorithm developed for the ITU-T P.862 standard for end-to-end speech quality assessment.

The hardware combination of, for example, the HiFi5 along with the NNE110 NPU, tackles the increased computational complexity often associated with DNN-based models and overcomes the challenges associated with implementing DNN-based applications in embedded systems. When implemented on the hardware combination described above, the detailed model 600 achieved an improvement of over 15% relative to models of similar size based on U-Net architecture as evaluated based on PESQ. It will be understood that the hardware combination can be used in either or both of training and inference.

### Speech Enhancement Using Deep Neural Network Methods and Operations

FIG. 8 is a flowchart illustrating a method 800 for improved real-time audio processing, according to embodiments of the present disclosure. In particular, the method 800 involves training a noise suppression model architecture (e.g., the ultra-small noise suppression model architecture 500 of FIG. 5A) and operating the model architecture in real-time. The method 800 may begin at block 802.

At block 802, audio data including a known noisy acoustic signal can be received. In some instances, the audio data may include a plurality of frames having a plurality of frequency bins. The audio data can be part of a training data set and the audio data can have separately known clean acoustic signal and/or known additive noise. The audio data can be known noisy acoustic signal or synthetic acoustic signal.

At block 804, the audio data can be transformed into frequency-domain data if the audio data is in the time-domain. Various types of Fourier transforms or its equivalents can be used to transform the audio data into the frequency-domain data.

At block 806, a convolutional neural network can be trained based on the frequency-domain data of the audio data and (i) the known clean acoustic signal or (ii) the known additive noise. In some implementations, the training can be conducted in a supervised manner with by iteratively tuning parameters of the convolutional neural network such that a known input matches or substantially matches to known output. For example, the parameters can be tuned such that the convolutional neural network substantially maps frequency-domain representations of the known noisy acoustic signal to frequency-domain representations the known clean acoustic signal. As another example, where the convolutional neural network is configured to output a frequency multiplicative mask, the parameters can be tuned such that applying the frequency multiplicative mask to frequency-domain representations of the known acoustic signal would substantially result in frequency-domain representation of the clean acoustic signal.

In some implementations, the convolutional neural network may be configured to output the known clean signal acoustic signal, the frequency multiplicative mask, or both. The convolutional neural network can include an encoder (e.g., an encoding layer) configured to upsample the frequency-domain data into a feature space and a decoder configured to downsample the feature space.

At block 808, optionally, the trained convolutional neural network can be provided to a wearable or a portable audio device. For example, the trained convolutional neural network. The audio device can receive real-time audio data and transform the real-time audio data into real-time frequency data. The audio device can use the trained convolutional neural network to determine a real-time frequency multiplicative mask by providing the received real-time audio data to the trained convolutional neural network. The audio device can apply the real-time frequency multiplicative mask to the real-time frequency domain audio to obtain clean audio data in real-time.

### Additional Embodiments

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A computer-implemented method comprising:
receiving audio data including a known noisy acoustic signal, the known noisy acoustic signal including a known clean acoustic signal and at least one known additive noise;
transforming the audio data into frequency-domain data; and
training a convolutional neural network based on the frequency-domain data and at least one of the known clean acoustic signal or the known additive noise,
wherein the convolutional neural network is configured to:
output a frequency multiplicative mask to be applied to the frequency-domain data to estimate the known clean acoustic signal, and
include an encoder configured to upsample the frequency-domain data into a feature space.

2. The computer-implemented method of claim 1 further comprising multiplying the frequency multiplicative mask to the frequency-domain data to estimate the known clean acoustic signal.

3. The computer-implemented method of claim 1 wherein spatial dimensions specified by width and height of the frequency-domain data remain the same before and after a performance of at least one 2-dimensional convolutional layer of the encoder.

4. The computer-implemented method of claim 1 wherein the convolutional neural network includes a decoder configured to downsample the feature space into the frequency multiplicative mask.

5. The computer-implemented method of claim 4 wherein spatial dimensions specified by width and height of the frequency-domain data remain the same before and after a performance of at least one 2-dimensional convolutional layer of the decoder.

6. The computer-implemented method of claim 1 further comprising constructing the convolutional neural network, including a plurality of neurons arranged in a plurality of layers including encoding layers and decoding layers wherein the encoding layers and decoding layers include 2-dimensional convolutional layers.

7. The computer-implemented method of claim 6 wherein each of the encoding layers and the decoding layers includes a 2-dimensional convolution followed by a batch normalization followed by a rectified linear unit activation.

8. The computer-implemented method of claim 6 wherein a first layer of the plurality of layers is configured to encode frequencies in the frequency-domain data into a higher-dimension feature space in comparison with an original dimension of the frequency-domain data, and a second layer of the plurality of layers is configured to decode feature space to lower-dimension in comparison with the higher-dimension feature space.

9. The computer-implemented method of claim 1 further comprising providing the trained convolutional neural network to a wearable or portable audio device wherein the audio device is capable of: receiving real-time audio data, transforming the real-time audio data into real-time frequency-domain data, outputting a real-time frequency multiplicative mask using the trained convolutional neural network and the real-time audio data, and applying the real-time frequency multiplicative mask to the real-time frequency-domain data.

10. The computer-implemented method of claim 1 wherein the frequency multiplicative mask is a phase-aware complex ratio mask.

11. The computer-implemented method of claim 1 wherein the known noisy acoustic signal is a known noisy speech signal and the known clean acoustic signal is a known clean speech signal.

12. A system comprising:
a combination of a high fidelity digital signal processor (HiFi DSP) paired with a neural processing unit (NPU) for real-time audio processing; and
one or more processors configured to execute instructions on the combination to perform a method comprising:
transforming input audio data into frequency-domain data;
perform inference with a trained convolutional neural network, executed on the combination of the HiFi DSP paired with the NPU, to output a frequency multiplicative mask, the convolutional neural network including an encoding layer configured to upsample the frequency-domain data into a feature space;
applying the frequency multiplicative mask to the frequency-domain data; and
estimating a noise suppressed version of the input audio data.

13. The system of claim 12 wherein the convolutional neural network includes a decoding layer configured to downsample the feature space into the frequency multiplicative mask.

14. The system of claim 13 wherein the encoding layer and the decoding layer include 2-dimensional convolutional layers.

15. The system of claim 13 wherein the decoding layer is configured to increase a number of channels.

16. The system of claim 12 wherein the HiFi DSP is of Tensilica® HiFi DSP family.

17. The system of claim 16 wherein the HiFi DSP is HiFi 5 DSP of Tensilica® HiFi DSP family.

18. The system of claim 12 wherein the NPU is of Tensilica® neural network engine (NNE) family.

19. The system of claim 18 wherein the NPU is NNE 110 of Tensilica® NNE family.

20. A computer-readable storage device storing instructions that, when executed by one or more processors, cause the one or more processors to perform a method comprising:
receiving audio data including a known noisy acoustic signal, the known noisy acoustic signal including a known clean acoustic signal and at least one known additive noise;
transforming the audio data into frequency-domain data; and
training a convolutional neural network based on the frequency-domain data and at least one of the known clean acoustic signal or the known additive noise,
wherein the convolutional neural network:
output a frequency multiplicative mask to be applied to the frequency-domain data to estimate the known clean acoustic signal, and
includes an encoder configured to upsample the frequency-domain data into a feature space.
